(19) United States
(12) Patent Application Publication
(10) Pub. No.: US 2026/0212107 A1
(43) Pub. Date: Jul. 23, 2026

(54) AUTOMATED COMPRESSION OF PROMPTS FOR GENERATIVE ARTIFICIAL INTELLIGENCE (AI) MODELS

(71) Applicant: AUTODESK, INC., San Francisco, CA (US)

(72) Inventors: George William FITZMAURICE, Toronto (CA); Jo Karel VERMEULEN, East York (CA); Justin Frank MATEJKA, Newmarket (CA)

(21) Appl. No.: 19/395,744

(22) Filed: Nov. 20, 2025

Related U.S. Application Data
(60) Provisional application No. 63/747,826, filed on Jan. 21, 2025.

(51) Int. Cl. G06F 40/126; G06N 20/00

(52) U.S. Cl. CPC G06F 40/126; G06N 20/00

(57) ABSTRACT

A computer-implemented method for compressing a long prompt for an artificial intelligence (AI) model, the method comprising generating an original similarity score for the long prompt and a long-prompt output that is generated by the AI model based on the long prompt, computing a set of feature scores for a set of features of the long prompt based, at least in part, on the original similarity score, determining a set of salient features included in the set of features based on the set of feature scores, and generating a short prompt based on the set of salient features, wherein the short prompt comprises a compressed version of the long prompt for inputting to the AI model to generate a short-prompt output.

### CROSS-REFERENCE TO RELATED APPLICATIONS

This application claims the benefit of U.S. Provisional Application titled “TECHNIQUES FOR IMPLEMENTING GENERATIVE AI PROMPT SIMPLIFICATION AND COMPRESSION” filed on January 21, 2025, and having Serial No. 63/747,826. The subject matter of this related application is hereby incorporated herein by reference.

### BACKGROUND

### Field of the Various Embodiments

The various embodiments relate generally to artificial intelligence and, more specifically, to automated compression of prompts for generative artificial intelligence (AI) models.

### Description of the Related Art

Current generative AI models can receive a text prompt as input and generate an output based on the text prompt. For example, the output can comprise an image, video, audio, or any other type of media object. When crafting a text prompt as input to a generative AI model, the first version typically does not capture the text the user desires, leading to several iterations to arrive at a final version of the text prompt that satisfies the user. The multiple iterations performed for crafting the text prompt typically result in an overly long and verbose prompt (referred to herein as a “long prompt”). Although such long prompts can generate outputs from the generative AI model that are desired by the user, long prompts have inherent drawbacks in terms of future reusability. In particular, relative to shorter and more concise prompts, long prompts are cumbersome and more difficult for the user to later modify, leverage to create other prompts, and/or generate variations of the long prompts for later follow-up work.

One conventional approach for shortening a long prompt to generate a short/compressed prompt is to input the long prompt to a Large Language Model (LLM) and query the LLM to summarize and shorten the long prompt. However, a drawback of this conventional approach is that the resulting short prompt typically generates an output from the generative AI model that is significantly different than the output generated by the long prompt. In particular, if the original long prompt is input to a generative AI model to generate a first output, and the short prompt is input to the same generative AI model to generate a second output, the second output is typically very different from the first output. For example, the first output can be a first image and the second output can be a second image that appears significantly altered from the first image. Such a result can be undesirable as the user is presumably satisfied with the original output generated by the long prompt and preferred a short prompt that could generate an output similar to the original output.

The above conventional approach implementing the LLM typically generates such an unsatisfactory short prompt due to the LLM being entirely uncoupled from the original output generated by the long prompt. In other words, the conventional approach typically implements the LLM to generate the short prompt based solely on the text contained in the long prompt and does not configure the LLM to consider the original output generated by the long prompt when generating the short prompt. As such, by uncoupling the original output generated by the long prompt from the generation of the short prompt, the LLM typically generates an unsatisfactory short prompt that generates an output that is similarly disconnected from the original output.

As the foregoing illustrates, what is needed in the art are more effective techniques for shortening/compressing long prompts for input to generative AI models.

### SUMMARY

In various embodiments, a computer-implemented method for compressing a long prompt for an artificial intelligence (AI) model, the method comprising generating an original similarity score for the long prompt and a long-prompt output that is generated by the AI model based on the long prompt, computing a set of feature scores for a set of features of the long prompt based, at least in part, on the original similarity score, determining a set of salient features included in the set of features based on the set of feature scores, and generating a short prompt based on the set of salient features, wherein the short prompt comprises a compressed version of the long prompt for inputting to the AI model to generate a short-prompt output.

At least one technical advantage of the disclosed techniques relative to the prior art is that the disclosed techniques implement an automated technique for generating a short/compressed prompt based on an original long prompt that generates a modified output that is significantly similar to an original output produced by the original long prompt when both prompts are input to the same generative AI model. The short/compressed prompt includes a lesser amount of text and fewer features relative to the long prompt, thereby providing greater future reusability relative to the long prompt. Such reusability includes later modification, building off or leveraging to generate other prompts, and/or making variations of the short prompt for subsequent follow-up work. The disclosed techniques connect the original output generated by the long prompt and the generation of the short/compressed prompt by implementing a similarity machine-learning (ML) model. The similarity ML model measures similarity between the original output and various versions of the long prompt to determine a set of most salient features for inclusion in the short/compressed prompt. In this manner, the resulting short/compressed prompt generates a modified output largely similar to the original output generated by the long prompt, while also providing greater future usability relative to the long prompt.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a prompt-compression system configured to implement one or more aspects of the various embodiments;

FIG. 2 is a screenshot of the prompt user interface (UI) displaying a long prompt of the prompt-compression system of FIG. 1, according to various embodiments;

FIG. 3 is a screenshot of the prompt user interface (UI) displaying a short prompt of the prompt-compression system of FIG. 1, according to various embodiments;

FIG. 4 is a screenshot of the prompt user interface (UI) displaying a set of UI tools of the prompt-compression system of FIG. 1, according to various embodiments;

FIGS. 5A-B set forth a flow diagram of method steps for compressing a long prompt, according to various embodiments;

FIG. 6 sets forth a flow diagram of method steps for performing a similarity function for generating a modified short prompt, according to various embodiments;

FIG. 7 sets forth a flow diagram of method steps for performing a length function for generating a modified short prompt, according to various embodiments;

FIG. 8 sets forth a flow diagram of method steps for performing a reverse prompt function for generating a modified short prompt, according to various embodiments; and

FIG. 9 depicts one architecture of a computing system 900, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

### System Overview

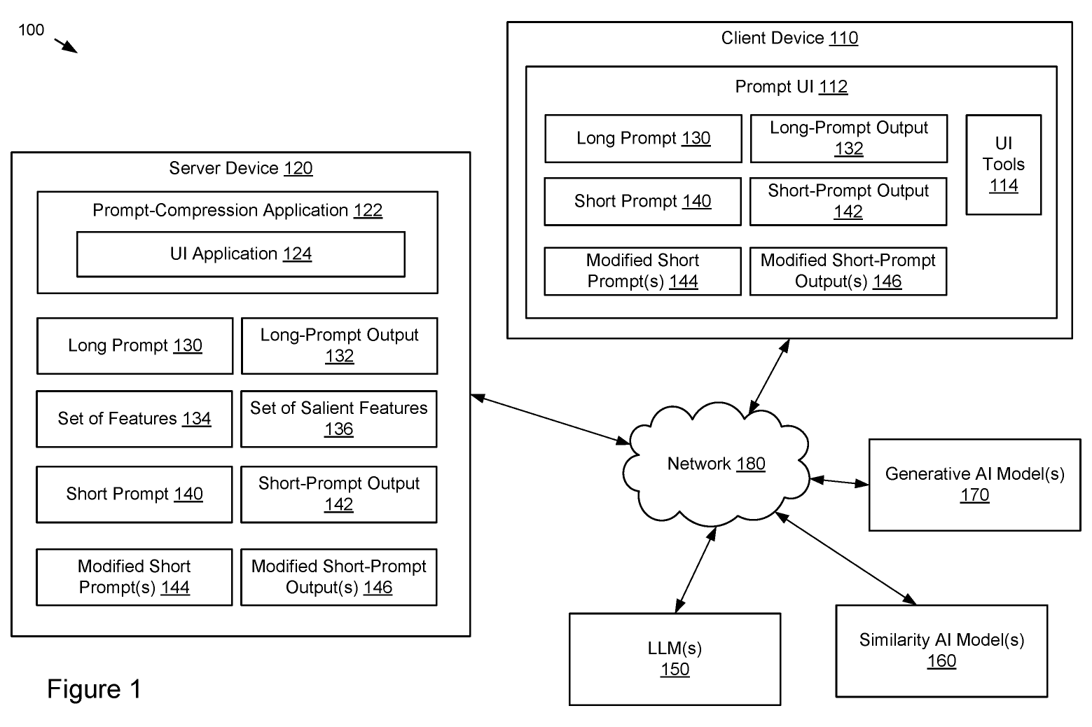

FIG. 1 is a conceptual illustration of a prompt-compression system 100 configured to implement one or more aspects of the various embodiments. As shown, in some embodiments, the prompt-compression system 100 includes, without limitation, a client device 110, a server device 120, one or more large language models (LLMs) 150, one or more similarity AI models 160, and one or more generative AI models 170 interconnected via a network 180.

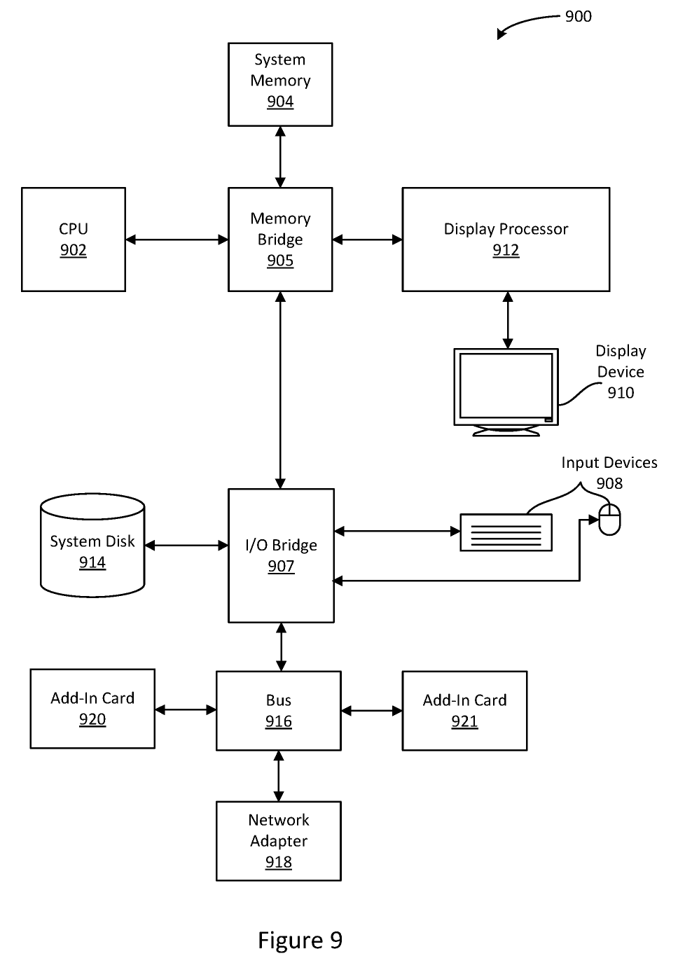

Each of the LLM(s) 150, similarity AI model(s) 160, and generative AI model(s) 170 can comprise a trained machine learning (ML) model, such as a trained neural network. Each of the client device 110, the server device 120, and the trained ML models 150, 160, and 170 can comprise computing systems that each include a memory and a processor configured to perform the techniques described herein. The computing components of the client device 110, the server device 120, and the trained ML models 150, 160, and 170 are discussed below in detail in relation to FIG. 9. In some other embodiments, the prompt-compression system 100 can include any number and/or types of other client devices 110, server devices 120, trained ML models 150, 160, and 170, or any combination thereof. Any number of the components of the prompt-compression system 100 can be distributed across multiple geographic locations or implemented across one or more cloud-based servers and computing environments (e.g., encapsulated shared resources, software, data) in any combination.

The various components of the prompt-compression system 100 are interconnected via the network 180. In particular, the client device 110, server device 120, and the trained ML models 150, 160, and 170 can be interconnected via the network 180 to enable communications and transfers of data between the various components of the prompt-compression system 100. The network 180 can be any technically feasible set of interconnected communication links, including a local area network (LAN), wide area network (WAN), the World Wide Web, or the Internet, among others. The network 180 enables communications between the various components of the prompt-compression system 100 via wired and/or wireless communications protocols, including Bluetooth, Bluetooth low energy (BLE), wireless local area network (WiFi), cellular protocols, satellite networks, and/or near-field communications (NFC).

The server device 120 includes and executes a prompt-compression application 122 that includes a UI application 124. The server device 120 further generates and stores data comprising a long prompt 130, a long-prompt output 132, a set of features 134, a set of salient features 136, a short prompt 140, a short-prompt output 142, one or more modified short prompts 144, and one or more modified short-prompt outputs 146. The client device 110 includes, without limitation, a prompt user interface (UI) 112 that can display a set of UI tools 114, the long prompt 130, the long-prompt output 132, the short prompt 140, the short-prompt output 142, the one or more modified short prompts 144, and the one or more modified short-prompt outputs 146.

In some embodiments, the prompt-compression application 122 executing on the server device 120 receives the long prompt 130 that produces the long-prompt output 132 and generates the short prompt 140 that produces the short-prompt output 142. In these embodiments, the short prompt 140 comprises a compressed version of the long prompt 130 while producing a short-prompt output 142 that is substantially similar to the long-prompt output 132. For example, relative to the long prompt 130, the short prompt 140 can have fewer text characters, a fewer number of words, a fewer number of sentences, or a fewer number of features, or any combination thereof. In this manner, the prompt-compression application 122 advantageously generates a short prompt 140 version of the long prompt 130 having greater future reusability, which also produces a short-prompt output 142 that is largely similar to the long-prompt output 132.

For example, the prompt-compression application 122 can receive the long prompt 130 from the client device 110, which can be created by the user with the assistance of an LLM 150. For example, the long prompt 130 can comprise a text-based description. The prompt-compression application 122 can then input the long prompt 130 to the generative AI model 170 and query the generative AI model 170 to generate a long-prompt output 132 based on the long prompt 130. The long-prompt output 132 can comprise an image, video, audio, three-dimensional (3D) object or geometry, or any other type of media object. For example, the long prompt 130 can include a text description of a visual scene that is to be generated by the generative AI model 170, and the long-prompt output 132 can comprise an image that captures the text description and illustrates the visual scene.

The prompt-compression application 122 can then generate an original similarity score between the long prompt 130 and the long-prompt output 132 that indicates a degree or level of similarity between the long prompt 130 and the long-prompt output 132. In some embodiments, the original similarity score indicates to what degree or level the long prompt 130 describes the long-prompt output 132, as well as to what degree or level the long-prompt output 132 captures the text description in the long prompt 130. The prompt-compression application 122 can generate the original similarity score by inputting the long prompt 130 and the long-prompt output 132 into a similarity AI model 160 and query the similarity AI model 160 to generate a similarity score based on the inputs.

The prompt-compression application 122 can select the type of similarity AI model 160 from a plurality of similarity AI models 160 to be used to generate the original similarity score based on the type of long-prompt output 132. For example, if the long-prompt output 132 comprises an image, a Contrastive Language-Image Pre-Training (CLIP) model can be used to generate the original similarity score. The CLIP model is configured to measure and quantify the level of similarity between pairs of text descriptions and images, such as a long prompt 130 and a long-prompt output 132, or a modified long prompt and the long-prompt output 132. In other embodiments, other types of similarity AI models 160 can be used based on the type of long-prompt output 132, such as a for 3D objects, videos, or audio.

The prompt-compression application 122 can then generate a set of features 134 included in the long prompt 130. For example, the prompt-compression application 122 can input the long prompt 130 into the LLM 150 and query the LLM 150 for a list of all separate or distinct features included in the long prompt 130. For example, a feature can comprise a text description of a specific noun or object (such as a vehicle or building) or a specific idea or concept (such as a futuristic city or menacing skyline).

The prompt-compression application 122 can then generate a set of salient features 136 comprising the most important and salient features included in the set of features 134. The prompt-compression application 122 can do so by iteratively modifying the long prompt 130 based on the set of features 134 to generate different versions of the long prompt 130. Subsequently, similarity scores for the different versions of the long prompt 130 and the long-prompt output 132 are generated to identify the most important features, the set of salient features 136, in the set of features 134. The set of salient features 136 comprises one or more features included in the set of features 134 that have a greatest effect or influence on the generation of the long-prompt output relative to other features in the set of features. Thus, the set of features 134 includes a set of salient features 136 and a set of non-salient features, wherein each salient feature 136 has a greater effect or influence on the generation of the long-prompt output 132 than each non-salient feature 136 included in the set of features 134.

In particular, for each feature in the set of features 134, the prompt-compression application 122 can remove the feature from the long prompt 130, while retaining all other features of the long prompt 130, to generate a modified long prompt and input the modified long prompt and the long-prompt output 132 to the similarity AI model 160, which generates a modified similarity score. The modified similarity score indicates a degree or level of similarity between the modified long prompt and the long-prompt output 132. Thus, the modified similarity score indicates to what degree or level the modified long prompt describes the long-prompt output 132, as well as to what degree or level the long-prompt output 132 captures the text description in the modified long prompt. The prompt-compression application 122 then compares the modified similarity score to the original similarity score to compute a feature score for the feature. The feature score for the feature indicates the level of effect or influence the feature has on the generation of the long-prompt output 132 by the generative AI model 170, where a higher feature score may indicate a greater level of effect or influence on the generation of the long-prompt output 132 than a lower feature score. In some embodiments, the inverse can be used where a lower feature score may indicate a greater level of effect or influence on the generation of the long-prompt output 132 than a higher feature score.

In general, if the modified similarity score is significantly lower than the original similarity score, this situation indicates the feature is relatively important and has a relatively greater effect or influence on the generation of the long-prompt output 132 by the generative AI model 170. In other words, the feature has a positive correlation to the long-prompt output 132, where removing the feature causes the modified long prompt to be less correlated to, and less descriptive of, the long-prompt output 132 relative to the long prompt. As such, the prompt-compression application 122 computes a relatively high feature score for the feature. If the modified similarity score is approximately the same or higher than the original similarity score, this situation indicates the feature is relatively not important and has a relatively lesser effect or influence on the generation of the long-prompt output 132 by the generative AI model 170. In other words, the feature has a neutral or negative correlation to the long-prompt output 132, where removing the feature causes the modified long prompt to be the same or more correlated to, the same or more descriptive of, the long-prompt output 132 relative to the long prompt. As such, the prompt-compression application 122 computes a relatively low feature score for the feature. The prompt-compression application 122 can then identify the set of salient features 136, the most important features, from the set of features 134 based on the feature scores computed for the set of features 134.

The prompt-compression application 122 can then generate the short prompt 140 based on the set of salient features 136. Notably, the set of features 134 includes a set of salient features 136 and a set of non-salient features (those features not included in the set of salient features 136), wherein each salient feature 136 has a greater effect or influence on the generation of the long prompt output 132 than each non-salient feature included in the set of features 134. In some embodiments, the short prompt 140 includes the entire set of salient features 136 from the set of features 134, but does not include any non-salient features from the set of features 134 or includes only a sub-portion of non-salient features from the set of features 134. In other embodiments, the short prompt 140 includes the entire set of salient features 136 from the set of features 134, but does not include at least one non-salient feature from the set of features 134. In some embodiments, the set of salient features 136 is highlighted (e.g., bolded) when displayed in the short prompt 140.

The prompt-compression application 122 can then input the short prompt 140 to the generative AI model 170 and query the generative AI model 170 to generate the short-prompt output 142 based on the short prompt 140. Given that a generative AI model 170 is used to generate both the short-prompt output 142 and the long-prompt output 132, the short-prompt output 142 will typically not be exactly the same as the long-prompt output 132. However, since the short prompt 140 includes the most salient or important features (the set of salient features 136) of the long prompt 130, the short-prompt output 142 will be significantly similar to the long-prompt output 132. In this manner, the prompt-compression application 122 couples the long-prompt output 132 produced by the long prompt 130 and the generation of the short prompt 140, which in turn generates the short-prompt output 142 that is largely similar to the original long-prompt output 132, while also providing greater future usability relative to the long prompt 130.

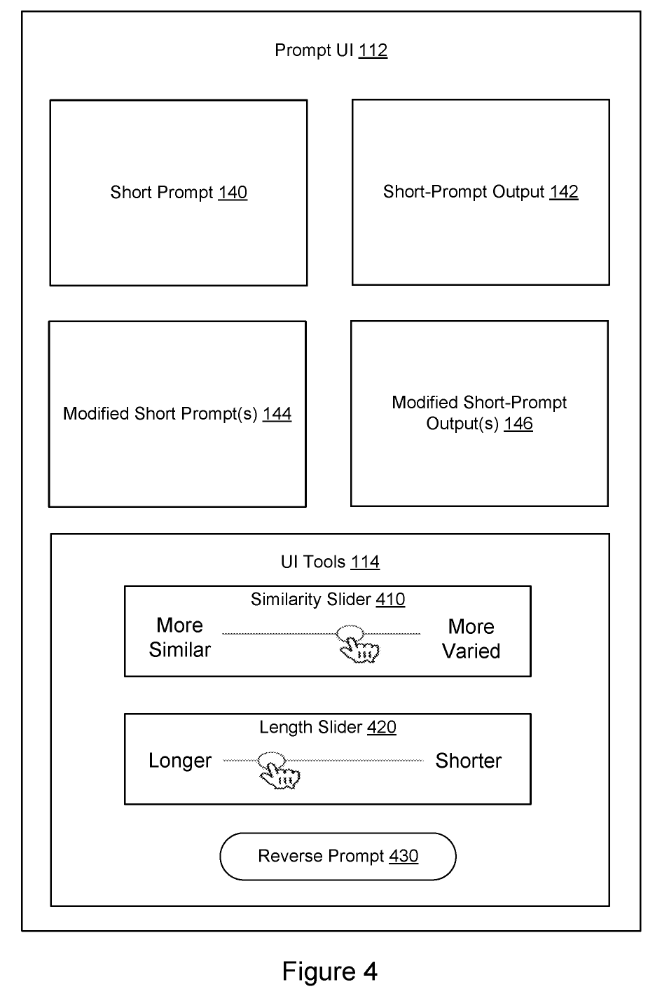

The prompt-compression application 122 also includes a UI application 124 that generates a prompt UI 112 that is displayed on the client device 110. The user of the client device 110 can interact with the prompt-compression application 122 via the prompt UI 112. The prompt UI 112 can display the various items processed or generated by the prompt-compression application 122, including the long prompt 130, the long-prompt output 132, the short prompt 140, and the short-prompt output 142. The UI application 124 also provides a set of UI tools 114 that is displayed via the prompt UI 112 on the client device 110. The user can interact with the UI tools 114 to provide user inputs to the prompt-compression application 122. The prompt-compression application 122 can generate one or more modified short prompts 144 based on the received user inputs, which are used to generate one or more modified short-prompt outputs 146 via the generative AI model 170, as discussed below in relation to FIG. 4.

### Compressing a Long Prompt

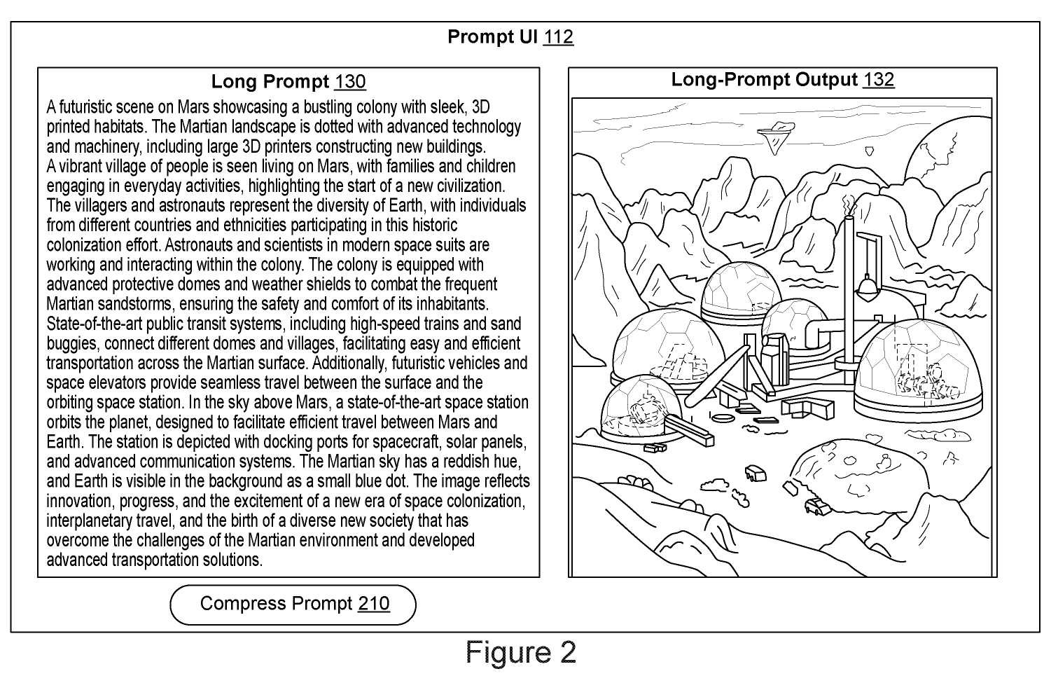

FIG. 2 is a screenshot of the prompt user interface (UI) 112 displaying a long prompt 130 of the prompt-compression system 100 of FIG. 1, according to various embodiments. As shown, the prompt UI 112 displays a long prompt 130 comprising a text description. In the example of FIG. 2, the long prompt 130 comprises a text description of a futuristic scene on Mars that describes a set of separate/distinct features 134, such as 3D printed habitats, advanced technology and machinery, large 3D printers, a diverse village of people, a new civilization, protective domes and weather shields, Martian sandstorms, state-of-the-art public transit, space station orbits, etc. For example, the prompt-compression application 122 can input the long prompt 130 into the LLM 150 and query the LLM 150 for a list of all separate/distinct features included in the long prompt 130. A feature identified by the LLM 150 can comprise a verbatim word or phrase included in the long prompt 130, such as “3D printed habitats” or “protective domes and weather shields.” However, a feature identified by the LLM 150 can also comprise a summary of a phrase or concept included in the long prompt 130, such as the feature “diverse village of people” being identified as a summary of the concept of “villagers and astronauts represent the diversity of Earth, with individuals from different countries and ethnicities” that is included in the long prompt 130.

The prompt-compression application 122 inputs the long prompt 130 to the generative AI model 170, which generates the long-prompt output 132. The prompt-compression application 122 executing on the server device 120 can then transmit the long-prompt output 132 to the client device 110, which displays the long-prompt output 132 via the prompt UI 112. In the example of FIG. 2, the long-prompt output 132 is an image that captures or reflects the text description included in the long prompt 130. As shown, the long-prompt output 132 comprises an image of a futuristic scene on Mars that includes at least some of the features in the set of features 134 of the long prompt 130. Notably, some features in the set of features 134 are of relatively greater importance and have a relatively greater effect or influence on the generation of the long-prompt output 132 by the generative AI model 170. However, other features in the set of features 134 are of relatively lesser importance and have a relatively lesser effect or influence on the generation of the long-prompt output 132 by the generative AI model 170.

As shown, the prompt UI 112 also displays a selectable “Compress Prompt” button 210. Upon the user selecting the “Compress Prompt” button 210, the prompt-compression application 122 compresses the long prompt 130 to generate a short prompt 140. The prompt-compression application 122 can do so by identifying a set of salient features 136 from the set of features 134. The set of salient features 136 includes the most salient or important features from the set of features 134 that have the greatest effect or influence on the generation of the long-prompt output 132 by the generative AI model 170. The prompt-compression application 122 can then generate the short prompt 140 based on the set of salient features 136. For example, the short prompt 140 can include the entire set of salient features 136 from the set of features 134 and include none or only some (but not all) of the non-salient features from the set of features 134. The prompt-compression application 122 executing on the server device 120 can then transmit the short prompt 140 to the client device 110, which displays the short prompt 140 via the prompt UI 112.

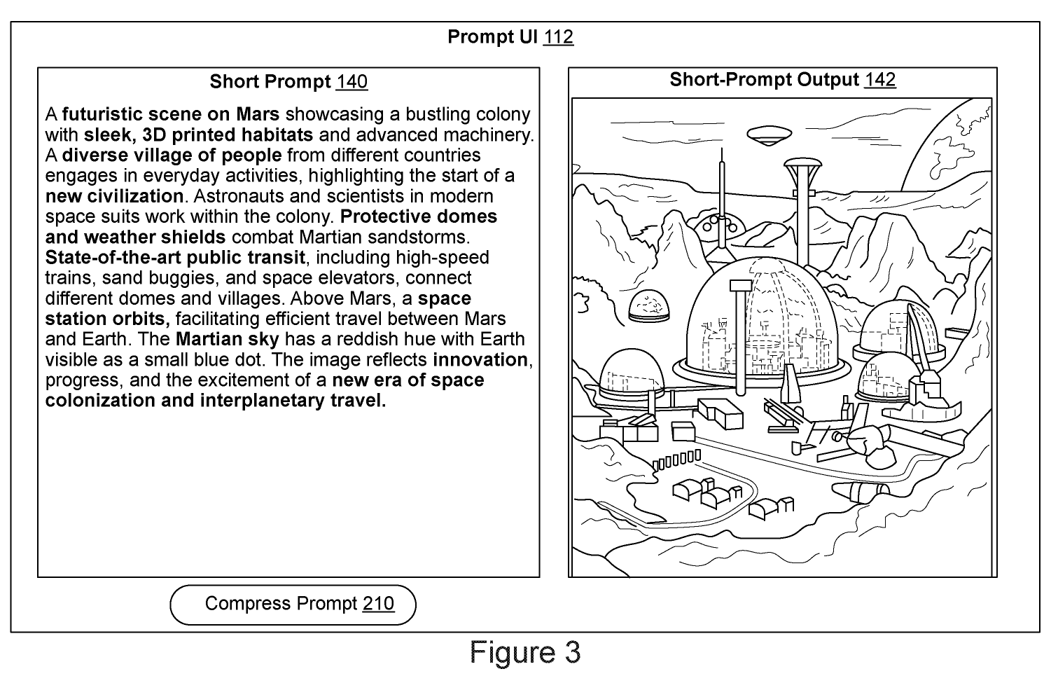

FIG. 3 is a screenshot of the prompt user interface (UI) 112 displaying a short prompt 140 of the prompt-compression system 100 of FIG. 1, according to various embodiments. As shown, the prompt UI 112 displays a short prompt 140 comprising a text description that is a compressed or shorter version of the text description included in the long prompt 130 of FIG. 2. The short prompt 140 includes a set of salient features 136 identified from the set of features 134, such as 3D printed habitats, advanced technology and machinery, large 3D printers, a diverse village of people, a new civilization, protective domes and weather shields, etc. The short prompt 140 can also include none or only some (but not all) of the non-salient features from the set of features 134. In some embodiments, the prompt UI 112 highlights the set of salient features 136 contained in the short prompt 140 when displaying the short prompt 140. In general, a salient feature in the short prompt 140 can be highlighted by displaying the salient feature in a first format that is distinct from a second format in which a remainder of text included in the short prompt 140 is displayed, such as by displaying the salient feature 136 in bold, underline, italics, or via any other highlighting technique.

The prompt-compression application 122 then inputs the short prompt 140 to the generative AI model 170, which generates the short-prompt output 142. The prompt-compression application 122 executing on the server device 120 can then transmit the short-prompt output 142 to the client device 110, which displays the short-prompt output 142 via the prompt UI 112. In the example of FIG. 3, the short-prompt output 142 is an image that captures or reflects the text description included in the short prompt 140. As shown, the short-prompt output 142 also comprises an image of a futuristic scene on Mars that includes at least some or all of the set of salient features 136 in the short prompt 140. As the short prompt 140 includes the most salient features of the long prompt 130, the short-prompt output 142 produced by the short prompt 140 (as shown in FIG. 3) will typically be significantly similar to the long-prompt output 132 produced by the long prompt 130 (as shown in FIG. 2).

### UI Tools for Modifying the Short Prompt

The UI application 124 of the prompt-compression application 122 also provides a set of UI tools 114 that is displayed via the prompt UI 112 on the client device 110. The user can interact with the UI tools 114 to provide user inputs to the prompt-compression application 122 for modifying the short prompt 140 to generate one or more modified short prompts 144. The prompt-compression application 122 can generate the one or more modified short prompts 144 based on user inputs, which are used to generate one or more modified short-prompt outputs 146 via the generative AI model 170. FIG. 4 is a screenshot of the prompt user interface (UI) 112 displaying a set of UI tools 114 of the prompt-compression system 100 of FIG. 1, according to various embodiments. As shown, the prompt UI 112 displays a short prompt 140, a short-prompt output 142, at least one modified short prompt 144, at least one modified short-prompt output 146, and a set of UI tools 114 comprising a selectable similarity slider 410, a selectable length slider 420, and a selectable “Reverse Prompt” button 430.

The user can interact with the similarity slider 410 to initiate a similarity function to generate a modified short prompt 144 that is different from the short prompt 140 while selecting the desired level of similarity to the short prompt 140. In particular, the user can interact with the similarity slider 410 to generate a modified short prompt 144 that is more similar to the short prompt 140 or more varied from the short prompt 140, which, in turn, will generate a modified short-prompt output 146 that is more similar or more varied, respectively, to the short-prompt output 142. The user can move a button along the similarity slider 410 to different positions along the similarity slider 410 to select different levels of similarity to the short prompt 140. The prompt-compression application 122 can then generate the modified short prompt 144 based on the position of the button along the similarity slider 410, which is then transmitted and displayed in the prompt UI 112 on the client device 110.

In particular, each selectable position of the button along the similarity slider 410 can be mapped to a corresponding percentage value. For example, the most far-left position (“More Similar”) on the similarity slider 410 can be mapped to a value of 10%, the most far-right position (“More Varied”) on the similarity slider 410 can be mapped to a value of 90%, and the positions between the most far-left position and the most far-right position can be mapped linearly to corresponding percentage values between 10% and 90%. In other embodiments, any other technique for mapping the selected position of the button along the similarity slider 410 to a corresponding percentage value can be implemented.

The corresponding percentage value indicates an amount of salient features in the set of salient features 136 of the short prompt 140 to be removed or modified. For example, when the user selects the most far-left position on the similarity slider 410, this selection indicates that 10% of the features in the set of salient features 136 of the short prompt 140 are to be deleted/removed or modified in some way (the feature is changed to a synonym, the feature is changed to an antonym, etc.). In response, the prompt-compression application 122 removes or modifies 10% of the set of salient features 136 of the short prompt 140 to generate the modified short prompt 144. Likewise, when the user selects the most far-right position on the similarity slider 410, this selection indicates that 90% of the features in the set of salient features 136 of the short prompt 140 are to be deleted/removed or modified in some way (the feature is changed to a synonym, the feature is changed to an antonym, etc.). In response, the prompt-compression application 122 removes or modifies 90% of the set of salient features 136 of the short prompt 140 to generate the modified short prompt 144.

Notably, the “10%” modified short prompt 144, generated by removing or modifying 10% of the set of salient features 136 of the short prompt 140, is “more similar” to the short prompt 140 than the “90%” modified short prompt 144, generated by removing or modifying 90% of the set of salient features 136 of the short prompt 140. The “90%” modified short prompt 144 is “more varied” from the short prompt 140 than the “10%” modified short prompt 144. As such, the “10%” modified short prompt 144 will generate a modified short-prompt output 146 that is “more similar” to the short-prompt output 142 than the modified short-prompt output 146 generated by the “90%” modified short prompt 144.

The user can interact with the length slider 420 to initiate a length function that generates a modified short prompt 144, which is more compressed or shorter than the short prompt 140, while selecting the desired level of compression of the short prompt 140. The user can move a button along the length slider 420 to different positions to select various levels of compression of the short prompt 140, which changes the length, specifically the amount of text or features, of the resulting modified short prompt 144. The prompt-compression application 122 can then generate the modified short prompt 144 based on the position of the button along the length slider 420. The modified short prompt 144 is then transmitted and shown in the prompt UI 112 on the client device 110.

In particular, each selectable position of the button along the length slider 420 can be mapped to a corresponding percentage value. For example, the most far-left position (“Longer”) on the length slider 420 can be mapped to a value of 10%, the most far-right position (“Shorter”) on the length slider 420 can be mapped to a value of 90%, and the positions between the most far-left position and the most far-right position can be mapped in a linear manner to corresponding percentage values between 10% and 90%. In other embodiments, any other technique for mapping position of the button along the length slider 420 to corresponding percentage values can be implemented.

The corresponding percentage value indicates the amount of salient features in the set of salient features 136 of the short prompt 140 to be removed. For example, when the user selects the most far-left position on the length slider 420, this selection indicates that 10% of the features in the set of salient features 136 of the short prompt 140 are to be deleted or removed. In response, the prompt-compression application 122 removes 10% of the set of salient features 136 of the short prompt 140 to generate the modified short prompt 144. Likewise, when the user selects the most far-right position on the length slider 420, the selection indicates that 90% of the features in the set of salient features 136 of the short prompt 140 are to be deleted or removed. In response, the prompt-compression application 122 removes 90% of the set of salient features 136 of the short prompt 140 to generate the modified short prompt 144. Notably, the “10%” modified short prompt 144, generated by removing 10% of the set of salient features 136 of the short prompt 140, will be “longer” in terms of the amount of text or features than the “90%” modified short prompt 144, generated by removing 90% of the set of salient features 136 of the short prompt 140, which is “shorter” in terms of the amount of text or features than the “10%” modified short prompt 144.

The user can select the “Reverse Prompt” button 430 to initiate a reverse prompt function that generates a modified short prompt 144. The modified short prompt 144 can be more compressed or shorter than the short prompt 140, while also utilizing different language or wording compared to the short prompt 140. The modified short prompt 144 can include a maximally compressed version (i.e., the shortest version) of the short prompt 140, which ultimately achieves greater efficiency and stability than the short prompt 140.

In particular, when the user selects the “Reverse Prompt” button 430, the prompt-compression application 122 inputs the short-prompt output 142 produced by the short prompt 140 into the LLM 150 and queries the LLM 150 to generate the shortest possible prompt that can generate the corresponding short-prompt output 142. The LLM 150 then generates the requested shortest possible prompt, comprising the modified short prompt 144. As the LLM 150 generates the modified short prompt 144, the modified short prompt 144 usually includes a text description that uses different language or wording than the corresponding short prompt 140. The prompt-compression application 122 can transmit the modified short prompt 144 to the client device 110 for display in the prompt UI 112.

In this manner, the user can interact with the similarity slider 410, length slider 420, and/or the “Reverse Prompt” button 430 to provide user inputs to the prompt-compression application 122. The prompt-compression application 122 can then generate one or more modified short prompts 144 based on the received user inputs. For each modified short prompt 144, the prompt-compression application 122 can input the modified short prompt 144 into the generative AI model 170, which generates a modified short-prompt output 146 based on the modified short prompt 144. The prompt-compression application 122 can transmit the one or more modified short prompts 144 and the one or more modified short-prompt outputs 146 to the client device 110 for display in the prompt UI 112. In some embodiments, any salient features 136 remaining in the modified short prompt 144 are displayed in the prompt UI 112 in a highlighted manner.

### Prompt Compression Flow Diagrams

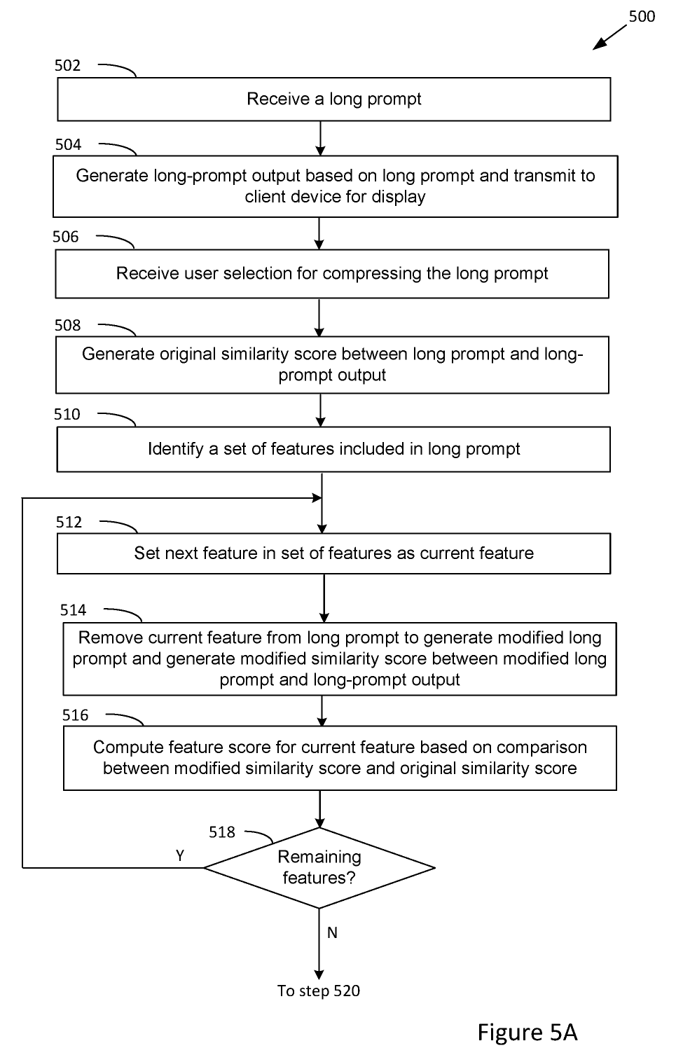

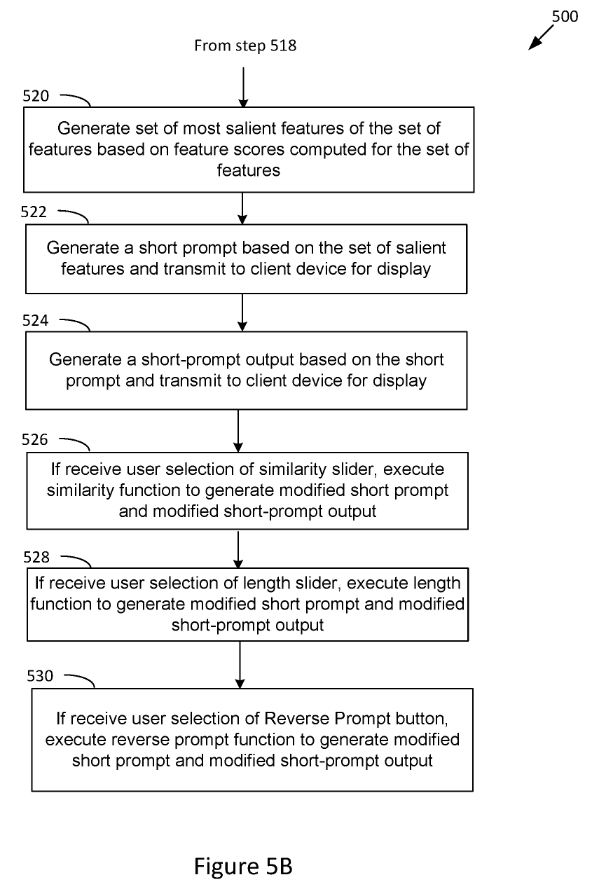

FIGS. 5A-B set forth a flow diagram of method steps for compressing a long prompt 130, according to various embodiments. Although the method steps are described with reference to the systems of FIGS. 1-4, persons skilled in the art will understand that any system configured to implement the method steps, in any order, falls within the scope of the embodiments. In some embodiments, the method 500 is executed by the prompt-compression application 122 residing and executing on the server device 120 in conjunction with the prompt UI 112 residing and executing on the client device 110.

The method 500 begins at step 502, where the prompt-compression application 122 receives a long prompt 130 from the client device 110. For example, the long prompt 130 can comprise a text-based description created by the user with the assistance of an LLM 150.

At step 504, the prompt-compression application 122 generates a long-prompt output 132 and transmits the long-prompt output 132 to the client device 110, which causes the long-prompt output 132 to be displayed in the prompt UI 112. The prompt-compression application 122 can do so by inputting the long prompt 130 to a generative AI model 170 and querying the generative AI model 170 to generate the long-prompt output 132 based on the long prompt 130. The long-prompt output 132 can comprise an image, video, audio, three-dimensional (3D) object or geometry, or any other type of media object.

At step 506, the prompt-compression application 122 receives, via the prompt UI 112, a user input selecting the “Compress Prompt” button 210 displayed in the prompt UI 112. The selection of the “Compress Prompt” button 210 indicates that the user desires a shorter/compressed version of the long prompt 130.

In response, at step 508, the prompt-compression application 122 generates an original similarity score between the long prompt 130 and the long-prompt output 132 that indicates a degree/level of similarity between the long prompt 130 and the long-prompt output 132. The prompt-compression application 122 can generate the original similarity score by inputting the long prompt 130 and the long-prompt output 132 into a similarity AI model 160 and querying the similarity AI model 160 to generate a similarity score based on the inputs. The prompt-compression application 122 selects the type of similarity AI model 160 to be used based on the type of long-prompt output 132. For example, if the long-prompt output 132 comprises an image, a CLIP model can be used to generate the original similarity score.

At step 510, the prompt-compression application 122 identifies a set of separate/distinct features 134 included in the long prompt 130. For example, the prompt-compression application 122 can input the long prompt 130 into the LLM 150 and query the LLM 150 for a list of all separate/distinct features included in the long prompt 130. The prompt-compression application 122 then processes each feature in the set of features 134 to determine a feature score for each feature to generate a set of features scores for the set of features 134, as discussed below in steps 512-518.

At step 512, the prompt-compression application 122 sets a next feature in the set of features 134 as a current feature for processing.

At step 514, the prompt-compression application 122 removes the current feature from the long prompt 130, retaining all other features of the long prompt 130, to generate a modified long prompt and generates a modified similarity score between the modified long prompt and long-prompt output 132. The prompt-compression application 122 can do so by inputting the modified long prompt and the long-prompt output 132 to the similarity AI model 160, which generates a modified similarity score that indicates a degree or level of similarity between the modified long prompt and the long-prompt output 132.

At step 516, the prompt-compression application 122 computes a feature score for the current feature based on a comparison between the modified similarity score and the original similarity score. In general, if the modified similarity score is significantly lower than the original similarity score, this situation indicates the current feature has relatively greater effect or influence on the generation of the long-prompt output 132, and thus a relatively higher feature score is computed for the current feature. If the modified similarity score is approximately the same or higher than the original similarity score, this situation indicates the current feature is relatively not important and has relatively lesser effect or influence on the generation of the long-prompt output 132, and thus a relatively lower feature score is computed for the current feature. In some embodiments, the feature score can be computed based on a delta/difference between the modified similarity score and the original similarity score using a predetermined equation that indicates a percentage difference. For example, the percentage difference can equal the (absolute value of (a - b) / average of a and b) * 100, where a = original similarity score and b = modified similarity score.

At step 518, the prompt-compression application 122 determines if there are any remaining features in the set of features 134 that have not been processed yet. If so, the method 500 returns to step 512 where the prompt-compression application 122 sets a next feature in the set of features 134 for processing. If not, all the features in the set of features 134 have been processed and thus the method 500 continues at step 520.

At step 520, the prompt-compression application 122 generates a set of salient features 136 based on the set of feature scores computed for the set of features 134. The set of salient features 136 comprises the most important or salient features included in the set of features 134. For example, the set of salient features 136 can include the top X% of features in the set of features 134 having the highest feature scores, X being a percentage value such as 10, 20, 30, 40, 50, etc. For example, the set of salient features 136 can include the top X features in the set of features 134 having the highest feature scores, X being a value such as 5, 10, 15, etc. For example, the set of salient features 136 can include the features in the set of features 134 having a predetermined minimum threshold feature score. In some embodiments, the set of salient features 136 can be determined based on the feature scores for the set of features 134 using any other type of technique.

At step 522, the prompt-compression application 122 generates the short prompt 140 based on the set of salient features 136 and transmits the short prompt 140 to the client device 110, which causes the short prompt 140 to be displayed in the prompt UI 112. In some embodiments, the short prompt 140 includes the entire set of salient features 136 from the set of features 134, and includes none of the non-salient features from the set of features 134 (those features not included in the set of salient features 136). In other embodiments, the short prompt 140 includes the entire set of salient features 136 from the set of features 134, and includes some but not all of the non-salient features from the set of features 134. For example, the short prompt 140 can include a predetermined percentage of the non-salient features from the set of features 134, such as 5%, 10%, etc. In some embodiments, the set of salient features 136 is configured to be highlighted (e.g., bolded) when displayed in the short prompt 140 via the prompt UI 112.

At step 524, the prompt-compression application 122 generates a short-prompt output 142 and transmits the short-prompt output 142 to the client device 110, which causes the short-prompt output 142 to be displayed in the prompt UI 112. The prompt-compression application 122 can do so by inputting the short prompt 140 to the generative AI model 170 and querying the generative AI model 170 to generate the short-prompt output 142 based on the short prompt 140. Since the short prompt 140 includes the most salient and important features (the set of salient features 136) of the long prompt 130, the short-prompt output 142 will be significantly similar to the long-prompt output 132.

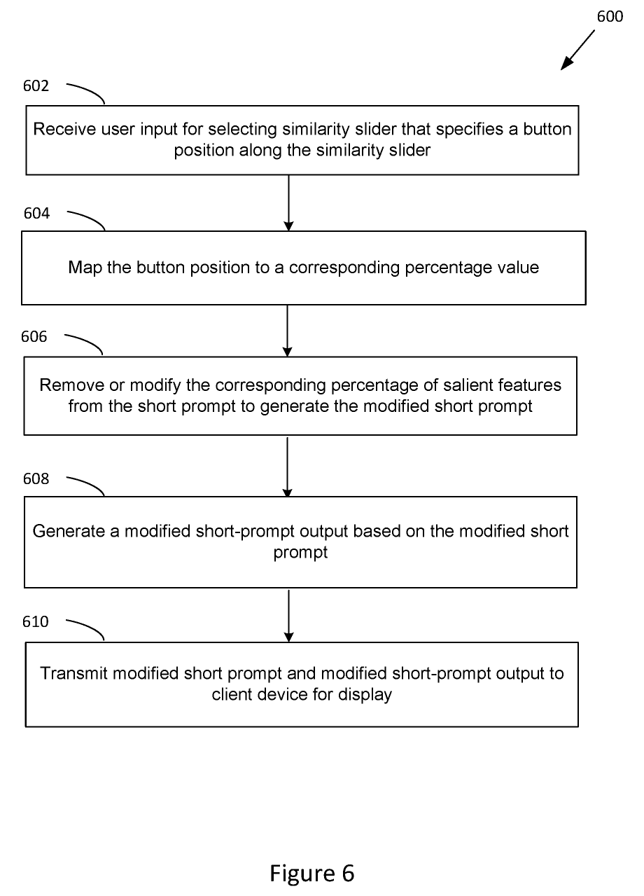

At step 526, if the prompt-compression application 122 receives, via the prompt UI 112, a user input selecting the similarity slider 410, the prompt-compression application 122 executes a similarity function to generate a modified short prompt 144 and a modified short-prompt output 146. The operations of the similarity function are discussed below in relation to FIG. 6.

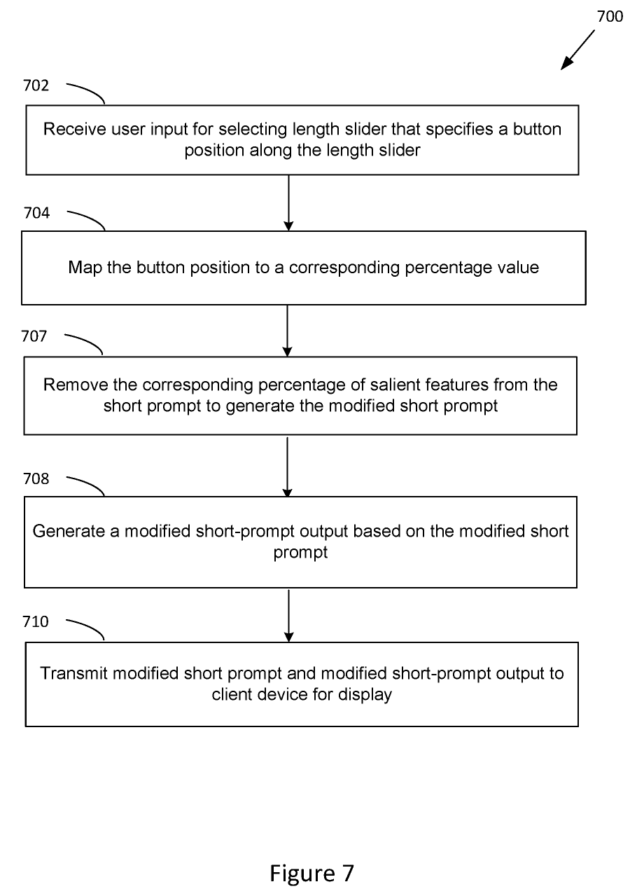

At step 528, if the prompt-compression application 122 receives, via the prompt UI 112, a user input selecting the length slider 420, the prompt-compression application 122 executes a length function to generate a modified short prompt 144 and a modified short-prompt output 146. The operations of the length function are discussed below in relation to FIG. 7.

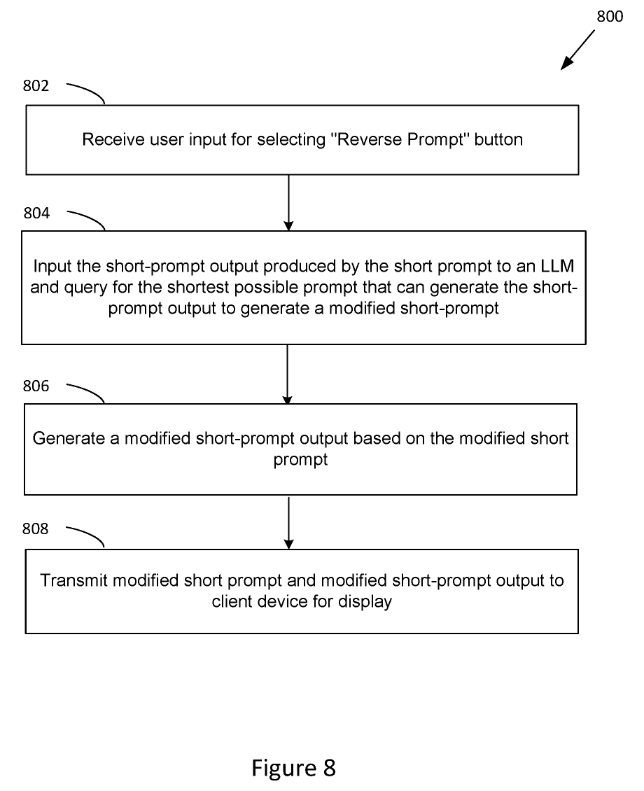

At step 530, if the prompt-compression application 122 receives, via the prompt UI 112, a user input selecting the “Reverse Prompt” button 430, the prompt-compression application 122 executes a reverse prompt function to generate a modified short prompt 144 and a modified short-prompt output 146. The operations of the reverse prompt function are discussed below in relation to FIG. 8. The method 500 then ends.

FIG. 6 sets forth a flow diagram of method steps for performing a similarity function for generating a modified short prompt 144, according to various embodiments. Although the method steps are described with reference to the systems of FIGS. 1-4, persons skilled in the art will understand that any system configured to implement the method steps, in any order, falls within the scope of the embodiments. In some embodiments, the method 600 is executed by the prompt-compression application 122 residing and executing on the server device 120 in conjunction with the prompt UI 112 residing and executing on the client device 110. In some embodiments, the method 600 comprises step 526 in the method 500 of FIGS. 5A-B.

The method 600 begins at step 602, when the prompt-compression application 122 receives, via the prompt UI 112, a user input selecting the similarity slider 410. The user input specifies a selected position of a moveable button along the similarity slider 410 that indicates a desired level of similarity or variance of the modified short prompt 144 from the short prompt 140.

At step 604, the prompt-compression application 122 maps the selected position of the moveable button to a corresponding predetermined percentage value. For example, the most far-left position (“More Similar”) on the similarity slider 410 can be mapped to a value of 10%, the most far-right position (“More Varied”) on the similarity slider 410 can be mapped to a value of 90%, and the positions between the most far-left position and the most far-right position can be mapped in a linear manner to corresponding percentage values between 10% and 90%. In other embodiments, any other technique for mapping the selected position of the button along the similarity slider 410 to a corresponding percentage value can be implemented.

At step 606, the prompt-compression application 122 generates the modified short prompt 144 based on the corresponding percentage value, the short prompt 140, and the set of salient features 136 associated with the short prompt 140. In particular, the prompt-compression application 122 removes or modifies only the corresponding percentage of salient features in the set of salient features 136 of the short prompt 140 to generate the modified short prompt 144. For example, a salient feature can be modified by replacing the salient feature with a synonym or an antonym. For example, if the corresponding percentage value is 10%, then only 10% of the salient features in the set of salient features 136 of the short prompt 140 are removed or modified to generate the modified short prompt 144, while the remaining salient features in the set of salient features 136 are left unchanged. Any technique can be used to select the particular salient features in the set of salient features 136 that are to be removed or modified. For example, the particular salient features to be removed or modified can be selected randomly or based on the feature scores associated with the salient features, such as selecting the salient features having the highest feature scores or the lowest feature scores.

At step 608, the prompt-compression application 122 generates a modified short-prompt output 146 by inputting the modified short prompt 144 to a generative AI model 170 and querying the generative AI model 170 to generate the modified short-prompt output 146 based on the modified short prompt 144.

At step 610, the prompt-compression application 122 transmits the modified short prompt 144 and the modified short-prompt output 146 to the client device 110, which causes the modified short prompt 144 and the modified short-prompt output 146 to be displayed in the prompt UI 112. In some embodiments, any salient features 136 remaining in the modified short prompt 144 are displayed in the prompt UI 112 in a highlighted manner. The method 600 then ends.

FIG. 7 sets forth a flow diagram of method steps for performing a length function for generating a modified short prompt 144, according to various embodiments. Although the method steps are described with reference to the systems of FIGS. 1-4, persons skilled in the art will understand that any system configured to implement the method steps, in any order, falls within the scope of the embodiments. In some embodiments, the method 700 is executed by the prompt-compression application 122 residing and executing on the server device 120 in conjunction with the prompt UI 112 residing and executing on the client device 110. In some embodiments, the method 700 comprises step 528 in the method 500 of FIGS. 5A-B.

The method 700 begins at step 702, when the prompt-compression application 122 receives, via the prompt UI 112, a user input selecting the length slider 420. The user input specifies a selected position of a moveable button along the length slider 420 that indicates a desired level of compression of the short prompt 140.

At step 704, the prompt-compression application 122 maps the selected position of the moveable button to a corresponding predetermined percentage value. For example, the most far-left position (“Longer”) on the length slider 420 can be mapped to a value of 10%, and the most far-right position (“Shorter”) on the length slider 420 can be mapped to a value of 90%. The positions between the most far-left position and the most far-right position can be mapped in a linear manner to corresponding percentage values between 10% and 90%. In other embodiments, any other technique for mapping the selected position of the button along the length slider 420 to a corresponding percentage value can be implemented.

At step 706, the prompt-compression application 122 generates the modified short prompt 144 based on the corresponding percentage value, the short prompt 140, and the set of salient features 136 associated with the short prompt 140. In particular, the prompt-compression application 122 removes only the corresponding percentage of salient features in the set of salient features 136 of the short prompt 140 to generate the modified short prompt 144. For example, if the corresponding percentage value is 10%, then only 10% of the salient features in the set of salient features 136 of the short prompt 140 are removed to generate the modified short prompt 144, while the remaining salient features in the set of salient features 136 are left unchanged. Any technique can be used to select the particular salient features in the set of salient features 136 that are to be removed. For example, the particular salient features to be removed can be selected randomly or based on the feature scores associated with the salient features (such as selecting the salient features having the highest feature scores or the lowest feature scores), etc.

At step 708, the prompt-compression application 122 generates a modified short-prompt output 146 by inputting the modified short prompt 144 to a generative AI model 170 and querying the generative AI model 170 to generate the modified short-prompt output 146 based on the modified short prompt 144.

At step 710, the prompt-compression application 122 transmits the modified short prompt 144 and the modified short-prompt output 146 to the client device 110, which causes the modified short prompt 144 and the modified short-prompt output 146 to be displayed in the prompt UI 112. In some embodiments, any salient features 136 remaining in the modified short prompt 144 are displayed in the prompt UI 112 in a highlighted manner. The method 700 then ends.

FIG. 8 sets forth a flow diagram of method steps for performing a reverse prompt function for generating a modified short prompt 144, according to various embodiments. Although the method steps are described with reference to the systems of FIGS. 1-4, persons skilled in the art will understand that any system configured to implement the method steps, in any order, falls within the scope of the embodiments. In some embodiments, the method 800 is executed by the prompt-compression application 122 residing and executing on the server device 120 in conjunction with the prompt UI 112 residing and executing on the client device 110. In some embodiments, the method 800 comprises step 530 in the method 500 of FIGS. 5A-B.

The method 800 begins at step 802, when the prompt-compression application 122 receives, via the prompt UI 112, a user input selecting the “Reverse Prompt” button 430. The selection of the “Reverse Prompt” button 430 indicates that the user wishes to generate a modified short prompt 144 that is more compressed/shorter than the short prompt 140, while also using different language or wording than the short prompt 140. The resulting modified short prompt 144 can comprise a maximally compressed version (i.e., the shortest version) of the short prompt 140.

At step 804, the prompt-compression application 122 inputs the short-prompt output 142 generated by the short prompt 140 to the LLM 150 and queries the LLM 150 to generate the shortest possible prompt that can generate the corresponding short-prompt output 142. The LLM 150 then generates the requested shortest possible prompt, which comprises the modified short prompt 144. Since the modified short prompt 144 is generated by the LLM 150, the modified short prompt 144 will typically include a text description that uses different language or wording than the corresponding short prompt 140.

At step 806, the prompt-compression application 122 generates a modified short-prompt output 146 by inputting the modified short prompt 144 to a generative AI model 170 and querying the generative AI model 170 to generate the modified short-prompt output 146 based on the modified short prompt 144.

At step 808, the prompt-compression application 122 transmits the modified short prompt 144 and the modified short-prompt output 146 to the client device 110, which causes the modified short prompt 144 and the modified short-prompt output 146 to be displayed in the prompt UI 112. In some embodiments, any salient features 136 remaining in the modified short prompt 144 are displayed in the prompt UI 112 in a highlighted manner. The method 800 then ends.

### System Implementation

FIG. 9 depicts one architecture of a computing system 900 within which the various embodiments may be implemented. In some embodiments, the client device 110, the server device 120, the one or more large language models (LLMs) 150, the one or more similarity AI models 160, and the one or more generative AI models 170 of FIG. 1 can each be implemented as a computing system 900 described herein. This figure in no way limits or is intended to limit the scope of the present disclosure. In various implementations, computing system 900 may be an augmented reality, virtual reality, or mixed reality system or device, a personal computer, video game console, personal digital assistant, mobile phone, mobile device, or any other device suitable for practicing one or more embodiments of the present disclosure. Further, in various embodiments, any combination of two or more systems 900 may be coupled together to practice one or more aspects of the present disclosure.

As shown, computing system 900 includes a central processing unit (CPU) 902 and a system memory 904 communicating via a bus path that may include a memory bridge 905. CPU 902 includes one or more processing cores, and, in operation, CPU 902 is the master processor of computing system 900, controlling and coordinating operations of other system components. System memory 904 stores software applications and data for use by CPU 902. CPU 902 runs software applications and optionally an operating system.

In particular, the system memory 904 stores content, such as software applications and data, for execution and processing by the CPU 902 to perform the functions and techniques described herein. For example, when the computing system 900 comprises the client device 110, the system memory 904 can store an application for the prompt UI 112 and data for the long prompt 130, the long-prompt output 132, the short prompt 140, the short-prompt output 142, the one or more modified short prompts 144, and the one or more modified short-prompt outputs 146, for execution and processing by the CPU 902 to perform the functions and techniques described herein. For example, when the computing system 900 comprises the server device 120, the system memory 904 can store an application for the prompt-compression application 122 and data for the long prompt 130, the long-prompt output 132, the set of features 134, the set of salient features 136, the short prompt 140, the short-prompt output 142, the one or more modified short prompts 144, and the one or more modified short-prompt outputs 146, for execution and processing by the CPU 902 to perform the functions and techniques described herein.

Memory bridge 905, which may be, e.g., a Northbridge chip, is connected via a bus or other communication path (e.g., a HyperTransport link) to an I/O (input/output) bridge 907. I/O bridge 907, which may be, e.g., a Southbridge chip, receives user input from one or more user input devices 908 (e.g., keyboard, mouse, joystick, digitizer tablets, touch pads, touch screens, still or video cameras, motion sensors, and/or microphones) and forwards the input to CPU 902 via memory bridge 905.

A display processor 912 is coupled to memory bridge 905 via a bus or other communication path (e.g., a PCI Express, Accelerated Graphics Port, or HyperTransport link); in one embodiment display processor 912 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 904.

Display processor 912 periodically delivers pixels to a display device 910 (e.g., a screen or conventional CRT, plasma, OLED, SED or LCD based monitor or television). Additionally, display processor 912 may output pixels to film recorders adapted to reproduce computer generated images on photographic film. Display processor 912 can provide display device 910 with an analog or digital signal. In various embodiments, one or more of the various user interfaces are displayed to one or more users via display device 910, and the one or more users can input data into and receive visual output from those various graphical user interfaces.

A system disk 914 is also connected to I/O bridge 907 and may be configured to store content and applications and data for use by CPU 902 and display processor 912. System disk 914 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 916 provides connections between I/O bridge 907 and other components such as a network adapter 918 and various add-in cards 920 and 921. Network adapter 918 allows computing system 900 to communicate with other systems via an electronic communications network, and may include wired or wireless communication over local area networks and wide area networks such as the Internet.

Other components (not shown), including USB or other port connections, film recording devices, and the like, may also be connected to I/O bridge 907. For example, an audio processor may be used to generate analog or digital audio output from instructions and/or data provided by CPU 902, system memory 904, or system disk 914. Communication paths interconnecting the various components in FIG. 1 may be implemented using any suitable protocols, such as PCI (Peripheral Component Interconnect), PCI Express (PCI- E), AGP (Accelerated Graphics Port), HyperTransport, or any other bus or point-to-point communication protocol(s), and connections between different devices may use different protocols, as is known in the art.

In one embodiment, display processor 912 incorporates circuitry optimized for graphics and video processing, including, for example, video output circuitry, and constitutes a graphics processing unit (GPU). In another embodiment, display processor 912 incorporates circuitry optimized for general purpose processing. In yet another embodiment, display processor 912 may be integrated with one or more other system elements, such as the memory bridge 905, CPU 902, and I/O bridge 907 to form a system on chip (SoC). In still further embodiments, display processor 912 is omitted and software executed by CPU 902 performs the functions of display processor 912.

Pixel data can be provided to display processor 912 directly from CPU 902. In some embodiments of the present disclosure, instructions and/or data representing a scene are provided to a render farm or a set of server computers, each similar to computing system 900, via network adapter 918 or system disk 914. The render farm generates one or more rendered images of the scene using the provided instructions and/or data. These rendered images may be stored on computer-readable media in a digital format and optionally returned to computing system 900 for display. Similarly, stereo image pairs processed by display processor 912 may be output to other systems for display, stored in system disk 914, or stored on computer-readable media in a digital format.

Alternatively, CPU 902 provides display processor 912 with data and/or instructions defining the desired output images, from which display processor 912 generates the pixel data of one or more output images, including characterizing and/or adjusting the offset between stereo image pairs. The data and/or instructions defining the desired output images can be stored in system memory 904 or graphics memory within display processor 912. In an embodiment, display processor 912 includes 3D rendering capabilities for generating pixel data for output images from instructions and data defining the geometry, lighting shading, texturing, motion, and/or camera parameters for a scene. Display processor 912 can further include one or more programmable execution units capable of executing shader programs, tone mapping programs, and the like.

Further, in other embodiments, CPU 902 or display processor 912 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 902, display processor 912, or one or more other processing devices or any combination of these different processors.

CPU 902, render farm, and/or display processor 912 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, computing system 900 may be a robot or robotic device and may include CPU 902 and/or other processing units or devices and system memory 904. In such embodiments, computing system 900 may or may not include other elements shown in FIG. 1. System memory 904 and/or other memory units or devices in computing system 900 may include instructions that, when executed, cause the robot or robotic device represented by computing system 900 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 904 is connected to CPU 902 directly rather than through a bridge, and other devices communicate with system memory 904 via memory bridge 905 and CPU 902. In other alternative topologies display processor 912 is connected to I/O bridge 907 or directly to CPU 902, rather than to memory bridge 905. In still other embodiments, I/O bridge 907 and memory bridge 905 might be integrated into a single chip. The particular components shown herein are optional; for instance, any number of add-in cards or peripheral devices might be supported. In some embodiments, switch 916 is eliminated, and network adapter 918 and add-in cards 920, 921 connect directly to I/O bridge 907.

In sum, the prompt-compression application 122 executing on the server device 120 receives a long prompt 130 that produces a long-prompt output 132 and generates a short prompt 140 that produces a short-prompt output 142. The short prompt 140 comprises a compressed version of the long prompt 130, while producing a short-prompt output 142 that is substantially similar to the long-prompt output 132 via a generative AI model 170.

In particular, the prompt-compression application 122 generates an original similarity score between the long prompt 130 and the long-prompt output 132 that indicates a degree or level of similarity between the long prompt 130 and the long-prompt output 132 via a similarity AI model 160. The prompt-compression application 122 can then generate a set of separate and distinct features 134 included in the long prompt 130. The prompt-compression application 122 can then generate a set of salient features 136 comprising the most important or salient features included in the set of features 134. The prompt-compression application 122 can do so by iteratively modifying the long prompt 130 based on the set of features 134 to generate different versions of the long prompt 130 and generating similarity scores for the different versions of the long prompt 130 and the long-prompt output 132 to identify the most important features (the set of salient features 136) in the set of features 134.

The prompt-compression application 122 can then generate the short prompt 140 based on the set of salient features 136. The prompt-compression application 122 can then input the short prompt 140 to the generative AI model 170 and query the generative AI model 170 to generate the short-prompt output 142 based on the short prompt 140. In this manner, the prompt-compression application 122 connects the long-prompt output 132 produced by the long prompt 130 and the generation of the short prompt 140, which in turn produces the short-prompt output 142 that is largely similar to the original long-prompt output 132. The prompt-compression application 122 can also generate one or more modified short prompts 144 based on user inputs received via a set of UI tools 114. The one or more modified short prompts 144 can be used to produce one or more modified short-prompt outputs 146 via the generative AI model 170.

At least one technical advantage of the disclosed techniques relative to the prior art is that the disclosed techniques implement an automated technique for generating a short/compressed prompt based on an original long prompt that generates a modified output that is significantly similar to an original output produced by the original long prompt when both prompts are input to the same generative AI model. The short/compressed prompt includes a lesser amount of text and fewer features relative to the long prompt, thereby providing greater future reusability relative to the long prompt. Such reusability includes later modification, building off or leveraging to generate other prompts, and/or making variations of the short prompt for subsequent follow-up work. The disclosed techniques connect the original output generated by the long prompt and the generation of the short/compressed prompt by implementing a similarity machine-learning (ML) model. The similarity ML model measures similarity between the original output and various versions of the long prompt to determine a set of most salient features for inclusion in the short/compressed prompt. In this manner, the resulting short/compressed prompt generates a modified output largely similar to the original output generated by the long prompt, while also providing greater future usability relative to the long prompt.

Aspects of the subject matter described herein are set out in the following numbered clauses.

1. In some embodiments, a computer-implemented method for compressing a long prompt for an artificial intelligence (AI) model comprises generating an original similarity score for the long prompt and a long-prompt output that is generated by the AI model based on the long prompt, computing a set of feature scores for a set of features of the long prompt based at least in part on the original similarity score, determining a set of salient features included in the set of features based on the set of feature scores, and generating a short prompt based on the set of salient features, wherein the short prompt comprises a compressed version of the long prompt for inputting to the AI model to generate a short-prompt output.

2. The computer-implemented method of clause 1, wherein the long prompt and the short prompt each comprise a text-based description.

3. The computer-implemented method of clauses 1 or 2, wherein the long prompt output and the short prompt output each comprise a media object.

4. The computer-implemented method of any of clauses 1-3, wherein computing the set of feature scores for the set of features of the long prompt comprises, for each feature in the set of features, performing the steps of generating a modified long prompt based on the feature and the long prompt, generating a modified similarity score for the modified long prompt and the long-prompt output, and generating a feature score for the feature based on the modified similarity score.

5. The computer-implemented method of any of clauses 1-4, wherein generating the modified long prompt comprises removing the feature from the long prompt.

6. The computer-implemented method of any of clauses 1-5, wherein the original similarity score indicates a level of similarity between the long prompt and the long-prompt output and the modified similarity score indicates a level of similarity between the modified long prompt and the long-prompt output.

7. The computer-implemented method of any of clauses 1-6, wherein generating the feature score for the feature comprises generating the feature score for the feature based on a comparison between the modified similarity score and the original similarity score.

8. The computer-implemented method of any of clauses 1-7, wherein the feature score for the feature indicates a level of influence the feature had on the generation of the long prompt output.

9. The computer-implemented method of any of clauses 1-8, wherein the set of salient features comprises one or more features included in the set of features having a greatest effect on the generation of the long prompt output relative to other features in the set of features.

10. The computer-implemented method of any of clauses 1-9, wherein the short prompt includes the set of salient features included in the set of features and at most a sub-portion of a set of non-salient features included in the set of features.

11. In some embodiments, one or more non-transitory computer-readable media include instructions that, when executed by one or more processors, cause the one or more processors to compress a long prompt for an artificial intelligence (AI) model by performing the steps of generating an original similarity score for the long prompt and a long-prompt output that is generated by the AI model based on the long prompt, computing a set of feature scores for a set of features of the long prompt based at least in part on the original similarity score, determining a set of salient features included in the set of features based on the set of feature scores, and generating a short prompt based on the set of salient features, wherein the short prompt comprises a compressed version of the long prompt for inputting to the AI model to generate a short-prompt output.

12. The one or more non-transitory computer-readable media of clause 11, wherein the long prompt and the short prompt each comprise a text-based description.

13. The one or more non-transitory computer-readable media of clauses 11 or 12, wherein the long prompt output and the short prompt output each comprise a media object comprising at least one of an image, a video, audio, or three-dimensional (3D) geometry.

14. The one or more non-transitory computer-readable media of any of clauses 11-13, wherein computing the set of feature scores for the set of features of the long prompt comprises, for each feature in the set of features, performing the steps of generating a modified long prompt based on the feature and the long prompt, generating a modified similarity score for the modified long prompt and the long-prompt output, and generating a feature score for the feature based on the modified similarity score.

15. The one or more non-transitory computer-readable media of any of clauses 11-14, wherein generating the modified long prompt comprises removing the feature from the long prompt.

16. The one or more non-transitory computer-readable media of any of clauses 11-15, wherein the original similarity score indicates a level of similarity between the long prompt and the long-prompt output and the modified similarity score indicates a level of similarity between the modified long prompt and the long-prompt output.

17. The one or more non-transitory computer-readable media of any of clauses 11-16, wherein generating the feature score for the feature comprises generating the feature score for the feature based on a comparison between the modified similarity score and the original similarity score.

18. The one or more non-transitory computer-readable media of any of clauses 11-17, further comprising generating a modified short prompt based on a user input indicating an amount of salient features in the set of salient features of the short prompt to be modified, wherein the modified short prompt comprises a modified version of the short prompt for inputting to the AI model to generate a modified short-prompt output.

19. The one or more non-transitory computer-readable media of any of clauses 11-18, further comprising generating a modified short prompt based on a user input indicating an amount of salient features in the set of salient features of the short prompt to be removed, wherein the modified short prompt comprises a compressed version of the short prompt for inputting to the AI model to generate a modified short-prompt output.

20. In some embodiments, a system comprises one or more memories storing instructions, and one or more processors coupled to the one or more memories that, when executing the instructions, compress a long prompt for an artificial intelligence (AI) model by performing the steps of generating an original similarity score for the long prompt and a long-prompt output that is generated by the AI model based on the long prompt, computing a set of feature scores for a set of features of the long prompt based at least in part on the original similarity score, determining a set of salient features included in the set of features based on the set of feature scores, and generating a short prompt based on the set of salient features, wherein the short prompt comprises a compressed version of the long prompt for inputting to the AI model to generate a short-prompt output.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments can be embodied as a system, method or computer program product. Accordingly, aspects of the present disclosure can take the form of an entirely hardware embodiment, an entirely software embodiment (including firmware, resident software, micro-code, etc.) or an embodiment combining software and hardware aspects that can all generally be referred to herein as a “module” or “system.” In addition, any hardware and/or software technique, process, function, component, engine, module, or system described in the present disclosure can be implemented as a circuit or set of circuits. Furthermore, aspects of the present disclosure can take the form of a computer program product embodied in one or more computer readable medium(s) having computer readable program code embodied thereon. The software constructs and entities (e.g., engines, modules, GUIs, etc.) are, in various embodiments, stored in the memory/memories shown in the relevant system figure(s) and executed by the processor(s) shown in those same system figures.

Any combination of one or more non-transitory computer readable medium or media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for compressing a long prompt for an artificial intelligence (AI) model, the method comprising:
generating an original similarity score for the long prompt and a long-prompt output that is generated by the AI model based on the long prompt;
computing a set of feature scores for a set of features of the long prompt based at least in part on the original similarity score;
determining a set of salient features included in the set of features based on the set of feature scores; and
generating a short prompt based on the set of salient features, wherein the short prompt comprises a compressed version of the long prompt for inputting to the AI model to generate a short-prompt output.

2. The computer-implemented method of claim 1, wherein the long prompt and the short prompt each comprise a text-based description.

3. The computer-implemented method of claim 1, wherein the long prompt output and the short prompt output each comprise a media object.

4. The computer-implemented method of claim 1, wherein computing the set of feature scores for the set of features of the long prompt comprises, for each feature in the set of features, performing the steps of:
generating a modified long prompt based on the feature and the long prompt;
generating a modified similarity score for the modified long prompt and the long-prompt output; and
generating a feature score for the feature based on the modified similarity score.

5. The computer-implemented method of claim 4, wherein generating the modified long prompt comprises removing the feature from the long prompt.

6. The computer-implemented method of claim 4, wherein the original similarity score indicates a level of similarity between the long prompt and the long-prompt output and the modified similarity score indicates a level of similarity between the modified long prompt and the long-prompt output.

7. The computer-implemented method of claim 4, wherein generating the feature score for the feature comprises generating the feature score for the feature based on a comparison between the modified similarity score and the original similarity score.

8. The computer-implemented method of claim 4, wherein the feature score for the feature indicates a level of influence the feature had on the generation of the long prompt output.

9. The computer-implemented method of claim 1, wherein the set of salient features comprises one or more features included in the set of features having a greatest effect on the generation of the long prompt output relative to other features in the set of features.

10. The computer-implemented method of claim 1, wherein the short prompt includes the set of salient features included in the set of features and at most a sub-portion of a set of non-salient features included in the set of features.

11. One or more non-transitory computer-readable media including instructions that, when executed by one or more processors, cause the one or more processors to compress a long prompt for an artificial intelligence (AI) model by performing the steps of:
generating an original similarity score for the long prompt and a long-prompt output that is generated by the AI model based on the long prompt;
computing a set of feature scores for a set of features of the long prompt based at least in part on the original similarity score;
determining a set of salient features included in the set of features based on the set of feature scores; and
generating a short prompt based on the set of salient features, wherein the short prompt comprises a compressed version of the long prompt for inputting to the AI model to generate a short-prompt output.

12. The one or more non-transitory computer-readable media of claim 11, wherein the long prompt and the short prompt each comprise a text-based description.

13. The one or more non-transitory computer-readable media of claim 11, wherein the long prompt output and the short prompt output each comprise a media object comprising at least one of an image, a video, audio, or three-dimensional (3D) geometry.

14. The one or more non-transitory computer-readable media of claim 11, wherein computing the set of feature scores for the set of features of the long prompt comprises, for each feature in the set of features, performing the steps of:
generating a modified long prompt based on the feature and the long prompt;
generating a modified similarity score for the modified long prompt and the long-prompt output; and
generating a feature score for the feature based on the modified similarity score.

15. The one or more non-transitory computer-readable media of claim 14, wherein generating the modified long prompt comprises removing the feature from the long prompt.

16. The one or more non-transitory computer-readable media of claim 14, wherein the original similarity score indicates a level of similarity between the long prompt and the long-prompt output and the modified similarity score indicates a level of similarity between the modified long prompt and the long-prompt output.

17. The one or more non-transitory computer-readable media of claim 14, wherein generating the feature score for the feature comprises generating the feature score for the feature based on a comparison between the modified similarity score and the original similarity score.

18. The one or more non-transitory computer-readable media of claim 11, further comprising generating a modified short prompt based on a user input indicating an amount of salient features in the set of salient features of the short prompt to be modified, wherein the modified short prompt comprises a modified version of the short prompt for inputting to the AI model to generate a modified short-prompt output.

19. The one or more non-transitory computer-readable media of claim 11, further comprising generating a modified short prompt based on a user input indicating an amount of salient features in the set of salient features of the short prompt to be removed, wherein the modified short prompt comprises a compressed version of the short prompt for inputting to the AI model to generate a modified short-prompt output.

20. A system comprising:
one or more memories storing instructions; and
one or more processors coupled to the one or more memories that, when executing the instructions, compress a long prompt for an artificial intelligence (AI) model by performing the steps of:
generating an original similarity score for the long prompt and a long-prompt output that is generated by the AI model based on the long prompt;
computing a set of feature scores for a set of features of the long prompt based at least in part on the original similarity score;
determining a set of salient features included in the set of features based on the set of feature scores; and
generating a short prompt based on the set of salient features, wherein the short prompt comprises a compressed version of the long prompt for inputting to the AI model to generate a short-prompt output.
